(19) United States
(12) Patent Application Publication
(10) Pub. No.: US 2008/0107945 A1
(43) Pub. Date: May 8, 2008

(54) FUEL CELL SUBSTRATE WITH AN OVERCOAT

(75) Inventors: Frank Coms, Fairport, NY (US); Jeanette E. O'Hara, Honeoye, NY (US)

Correspondence Address: GENERAL MOTORS CORPORATION;LEGAL STAFF, MAIL CODE 482-C23-B21, P O BOX 300, DETROIT, MI, 48265-3000, US

(73) Assignee: GM Global Technology Operations, Inc., Detroit, MI (US)

(21) Appl. No.: 11/557,592

(22) Filed: Nov. 8, 2006

(51) Int. Cl. H01M 8/10; B05D 5/12; H01M 4/00

(52) U.S. Cl. 429/30; 427/115; 429/40

(57) ABSTRACT

A fuel cell substrate with an overcoat including an ionomer modified to include a cerium or manganese group and methods of making and using the same.

### TECHNICAL FIELD

The field to which the disclosure generally relates includes fuel cells and components thereof including ionomer overcoats, electrodes, membranes, catalyst coated membranes, catalyst coated diffusion media, and products including the same and methods of making and using the same.

### BACKGROUND

Fuel cells using solid polyelectrolyte membranes are known. Those skilled in the art are continually working on membranes, membrane assemblies and methods of making and using the same that improve the durability of the membrane and providing alternative embodiments. The present invention provides an alternative to membranes, membrane assemblies, and methods of making and using the same in the prior art.

### SUMMARY OF EXEMPLARY EMBODIMENTS OF THE INVENTION

One embodiment of the invention includes a product comprising a fuel cell substrate with an overcoat over the substrate, the overcoat comprising an ionomer comprising a Ce or Mn group.

One embodiment of the invention includes a method comprising applying a solution over fuel cell substrate, the solution including an ionomer modified with a cerium or a manganese ion.

One embodiment of the invention includes substituting a Ce or Mn ion for a proton group of an ionomer including mixing a salt of Ce or Mn with the ionomer in a solution.

Another embodiment of the invention includes a method comprising modifying an ionomer comprising dissolving a salt of Ce³⁺ or Mn²⁺ in a solution including the ionomer and a vehicle.

Other exemplary embodiments of the present invention will become apparent from the detailed description provided hereinafter. It should be understood that the detailed description and specific examples, while disclosing exemplary embodiments of the invention, are intended for purposes of illustration only and are not intended to limit the scope of the invention.

### BRIEF DESCRIPTION OF THE DRAWINGS

Exemplary embodiments of the present invention will become more fully understood from the detailed description and the accompanying drawings, wherein:

FIG. 1 illustrates one embodiment of the invention including a cerium or manganese ion modified ionomer overcoat over an electrode including a catalyst.

FIG. 2 illustrates one embodiment of the invention including hot pressing an electrode with a catalyst and an ion modified overcoat onto a membrane using a decal transfer process.

FIG. 3 illustrates one embodiment of the invention including a catalyst coated membrane including an ion modified ionomer overcoat underlying the catalyst layer.

FIG. 4 illustrates another embodiment of the invention including a catalyst coated diffusion media (with a microporous layer) including an ion modified ionomer layer overlying the catalyst layer.

FIG. 5 illustrates another embodiment of the invention including a catalyst coated diffusion media (without a microporous layer) including an ion modified ionomer layer overlying the catalyst layer directly on the diffusion media layer.

FIG. 6 illustrates one embodiment of the invention including a catalyst coated membrane including an ion modified ionomer overcoat over the catalyst layer that is interposed between the membrane and the ionomer overcoat.

FIG. 7 illustrates another embodiment of the invention including a catalyst coated diffusion media (with a microporous layer) including an ion modified ionomer layer interposed between the catalyst layer and the microporous layer.

FIG. 8 illustrates one embodiment of the invention including a portion of a fuel cell including a membrane electrode assembly including an anode and cathode layer and an ion modified ionomer layer interposed between each of the anode layer and cathode layer and the membrane.

FIG. 9 illustrates one embodiment of the invention including a portion of a fuel cell including a membrane electrode assembly including an anode and cathode layer and an ion modified ionomer layer over each of the anode layer and cathode layer.

FIG. 10 illustrates one embodiment of the invention including a portion of a fuel cell including a membrane electrode assembly including an anode and cathode layer and an ion modified ionomer layer interposed between each of the anode layer and cathode layer and the membrane, and a second ion modified ionomer layer over each of the anode layer and cathode layer.

FIG. 11 is a graph of the voltage versus current density for a membrane electrode assembly including an ionomer modified overcoat according to one embodiment of the invention.

FIG. 12 is a graph of the results of a durability test of a membrane electrode assembly including an ionomer modified overcoat according to one embodiment of the invention.

FIG. 13 illustrates another embodiment of the invention.

### DETAILED DESCRIPTION OF EXEMPLARY EMBODIMENTS

The following description of the embodiment(s) is merely exemplary in nature and is in no way intended to limit the invention, its application, or uses.

One embodiment of the invention includes a method including modifying an ionomer by dissolving a salt of Ce³⁺ or Mn²⁺ in a solution including the ionomer and a vehicle. In one embodiment, the salt is the carbonate salt of Ce³⁺ or Mn²⁺. In one embodiment, the salt includes Ce₂(CO₃)₃ or MnCO₃. In one embodiment, the vehicle may include water or an alcohol, such as ethanol, methanol, propanol, butanol or the like, or mixtures thereof.

The ionomer material is a polyelectrolyte material and is ion-conductive. Examples of such suitable polyelectrolyte materials are disclosed in U.S. Pat. Nos. 4,272,353 and 3,134,689, and in the Journal of Power Sources, Volume 28 (1990), pages 367-387. Such materials are also known as ion-exchange resins. The resins include ionic groups in their polymeric structure; one ionic component for which is fixed or retained by the polymeric matrix and at least one other ionic component being a mobile replaceable ion electrostatically associated with the fixed component. The ability of the mobile ion to be replaced under appropriate conditions with other ions imparts ion exchange characteristics to these materials.

The ion exchange resins can be prepared by polymerization of a mixture of ingredients, one of which is an ionic constituent. One broad class of cationic exchange, proton conductive resins is the so-called sulfonic acid cationic exchange resin. In the sulfonic acid resins, the cationic exchange groups are sulfonic acid groups which are attached to the polymer backbone.

In one embodiment of the invention, the ion exchange resin is a perfluorinated sulfonic acid polymer electrolyte which includes ionic exchange characteristics. Such polymer electrolytes are available, from E. I. DuPont de Nemours & Company under the trade designation NAFION®. Other such polyelectrolyte materials are available from Asahi Glass and Asahi Kasei Chemical Company. The use of other polyelectrolyte materials such as, but not limited to, perfluorinated cationic-exchange resins, hydrocarbon based cationic-exchange resins as well as anion-exchange resins are all within the scope of the invention.

Another embodiment of the invention includes a method comprising applying an ionomer solution to a substrate. The ionomer solution includes an ionomer modified to include a cerium and/or manganese ion group. The ionomer may be modified as described below. In various embodiments of the invention, the ionomer solution may be applied by spraying, dipping, screen printing, electrostatic printing, spin-coating, rolling or the like. In various embodiments of the invention, the substrate on which the ionomer solution is applied may include, but is not limited to, a decal backing, a polyelectrolyte membrane, a gas diffusion media layer, a microporous layer, a catalyst coated gas diffusion media, a catalyst coated membrane, or an electrode including a catalyst. The vehicle is allowed to evaporate to provide a solid overcoat over the substrate.

In another embodiment of the invention, 50 grams of Asahi Kasei ionomer solution (5 percent by weight ionomer, equivalent weight=900) were added to 202 milligrams (0.44 mmol) of Ce₂ (CO₃)₃.H₂O. The resulting solution was briefly warmed to 40° C. and allowed to stir at room temperature overnight. The resulting solution was diluted with 200 grams of methanol to produce a one percent by weight ionomer solution. The diluted ionomer solution (70 mL) was sprayed onto a catalyst decal to give a final ionomer overspray overage of about 0.2 mg/cm². The large catalyst decal was die-cut into 50 cm² decals for membrane electrode assembly. Using this procedure, the cerium content in 50 cm² catalyst decal is approximately 0.5 mg Ce (3.6 μmol). The modified decals were then hot pressed to a NAFION® 112 membrane for four minutes at 295° F. under a force of 4,000 pounds (300 psi). The active area of the anode and cathode were 38 and 44 cm², respectively.

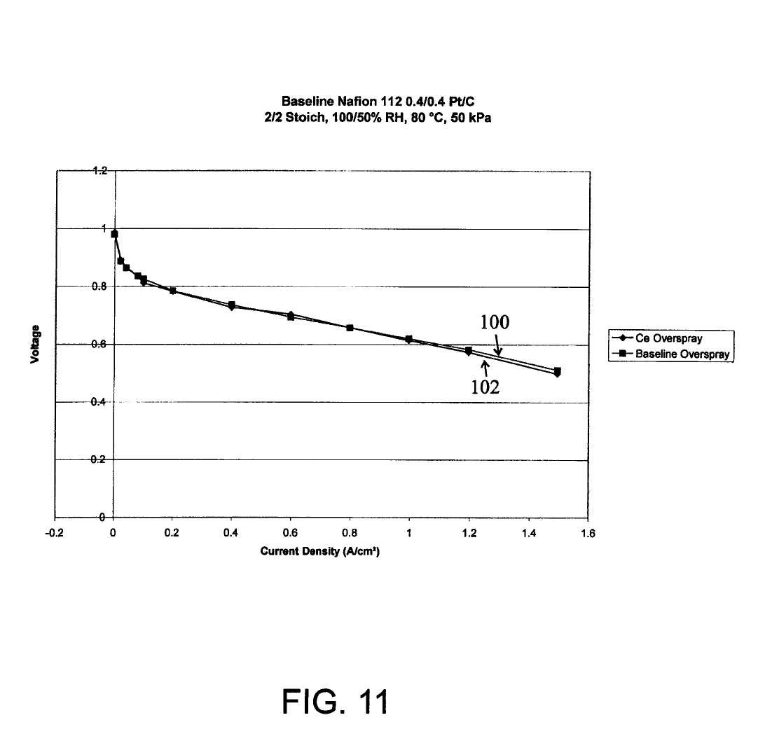

The membrane electrode assemblies were fitted into 50 cm² hardware for fuel cell testing. The beginning of life performance of the membrane electrode assembly was evaluated via its H₂/air polarization curve from 0 to 1.5 A/cm² at 80° C. The gas pressures were 150 kPa abs and the anode and cathode relative humidities were 100 and 50%, respectively. The stoichiometries were 2.0 for both anode and cathode. The platinum loadings for both anode and cathode electrodes were 0.4 mg/cm². FIG. 11 is a graph of the voltage vs. current density polarization curve for a membrane electrode assembly including a cerium-modified ionomer overcoat in comparison to a conventional membrane electrode assembly. FIG. 11 is a graph of the voltage versus current density for a membrane electrode assembly including an ionomer modified overcoat according to one embodiment of the invention. In FIG. 11, line 102 represents a Ce overspray (ionomer modified with Ce) and line 100 represents a baseline overspray (without ionomer modified by an ion). FIG. 11 shows that there is no performance penalty associated with the use of metal-ion modified ionomer overcoats of the present invention.

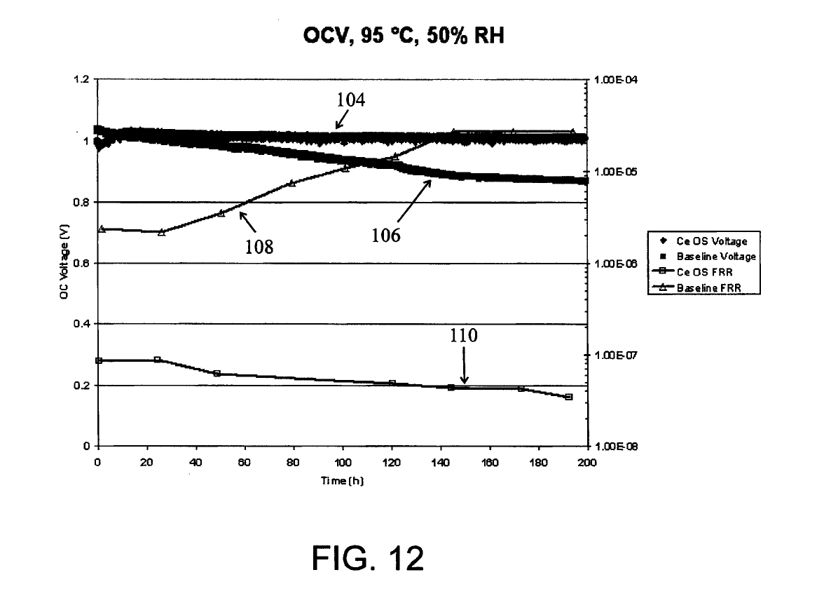

The membrane electrode assembly durability was evaluated by monitoring voltage and fluoride release rates (FRR) during operation under open circuit conditions at 95° C. and 50% relative humidity for both anode and cathode. Voltage degradation rates and the fluoride release rates (FRR) of membrane electrode assemblies of this invention were evaluated in comparison with a baseline membrane electrode assembly prepared with a conventional overspray of a non-modified ionomer solution. FIG. 12 is a graph of the results of the durability test of a membrane electrode assembly including an ionomer modified overcoat according to one embodiment of the invention. In FIG. 12, line 104 represents the Ce OS Voltage (i.e., voltage for ionomer modified with Ce ions), line 106 represents the baseline voltage (ionomer not modified with ions), line 110 represents Ce oversray FRR, and line 108 represents a baseline FRR). It is clear that employing a metal-ion modified ionomer overspray as described in this invention leads to dramatic reductions in both the voltage degradation rates and FRR. In the example of FIG. 12, the voltage degradation rate decreases by a factor of 20 and the FRR decreases by a factor of 500. These results demonstrate that the present invention provides profound improvements in membrane durability.

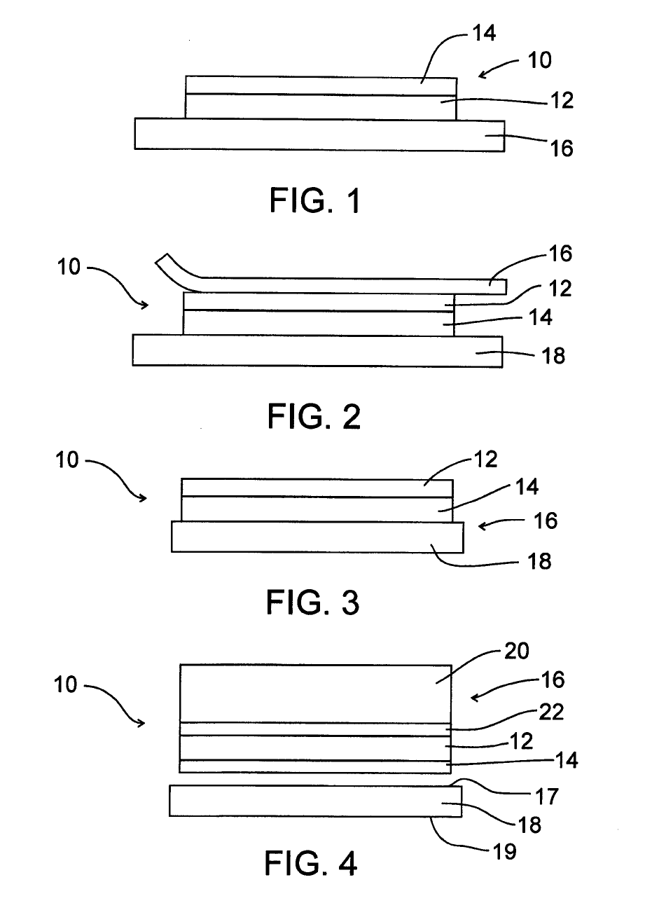

Referring now to FIG. 1, one embodiment of the invention may include a product 10 comprising an electrode layer 12 having a catalyst. An overcoat 14 is provided over the electrode layer 12. The overcoat 14 includes a cerium or manganese modified ionomer. The catalyst may be supported or unsupported. The electrode layer 12 may include a group of finely divided particles supporting finely divided catalyst particles such as platinum, and an ion conductive material such as a proton conducting ionomer, intermingled with particles. The proton conductive materials may be an ionomer such as a perfluorinated sulfonic acid polymer or any of the other ionomers described above. The catalyst materials may include metals such as platinum, palladium, and mixtures of metals such as platinum and molybdenum, platinum and cobalt, platinum and ruthenium, platinum and nickel, platinum and tin, other platinum transitional metal alloys, intermetallic compounds, and other fuel cell electrocatalysts known in the art. The support particles are electrically conductive and may include carbon. The support particles may include, but are not limited to, electrically conductive macromolecules of activated carbon, carbon nanotubes, carbon fibers, mesopore carbon, and other electrically conductive particles with suitable surface area to support the catalyst. The substrate 16 may include a decal backing material, a polyelectrolyte membrane, or a gas diffusion media layer.

Referring now to FIG. 2, a product 10 according to one embodiment of the invention includes an electrode layer 12 including a catalyst and an overcoat 14 over the catalyst layer 12. The overcoat 14 includes a cerium or manganese modified ionomer. A substrate 16, which in this embodiment is a decal backing, that supports the electrode layer 12 and the overcoat 14. The assembly may be placed on a polyelectrolyte membrane 18 with the overcoat 14 facing the polyelectrolyte membrane 18 and hot pressed so that the overcoat 14 and electrode layer 12 adhere to the polyelectrolyte membrane 18 and the decal backing 16 may be pulled off to produce the resultant structure shown in FIG. 3.

FIG. 4 illustrates a product 10 according to another embodiment of the invention wherein the substrate 16 includes a gas diffusion media layer 20 and an optional microporous layer 22. The gas diffusion media layer 20 and/or microporous layer 22 is coated with an electrode layer 12 to provide a first catalyst coated diffusion media. An overcoat 14 is applied to the first catalyst coated diffusion media. The catalyst coated diffusion media with overcoat 14 may be placed against a first face 17 of a polyelectrolyte membrane 18. A second catalyst coated diffusion media layer with an overcoat 14 may be placed so that the overcoat 14 engages a second face 19 of the polyelectrolyte membrane 18. The first catalyst coated diffusion media with overcoat, membrane, and second catalyst coated diffusion media with overcoat may be hot pressed together.

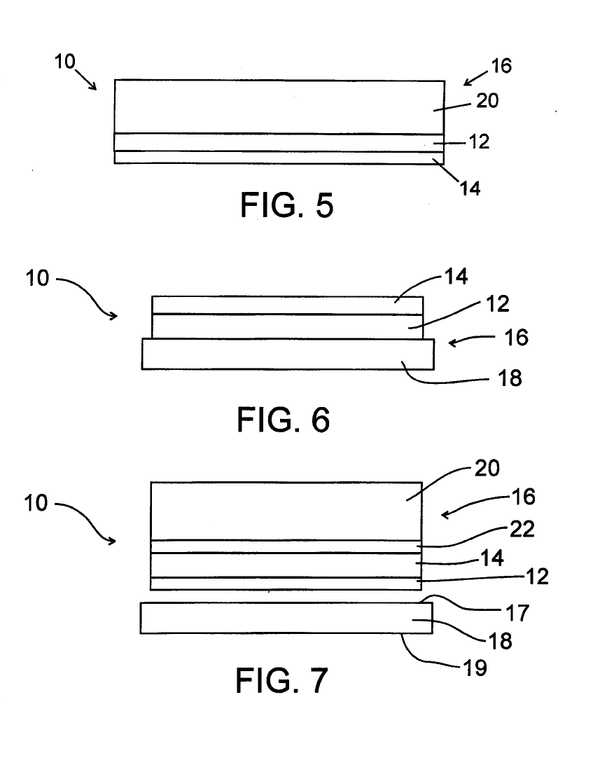

FIG. 5 illustrates a product 10 according to one embodiment of the invention comprising an overcoat layer 14 including a cerium or manganese modified ionomer over a substrate 16. The substrate 16 may be a gas diffusion media layer 20 without a microporous layer and a catalyst layer 12 interposed between the gas diffusion media layer 20 and the overcoat layer 14.

FIG. 6 illustrates a product 10 according to one embodiment of the invention including a catalyst coated membrane including an ion modified ionomer overcoat 14 over the catalyst layer 12 that is interposed between the membrane 18 and the ionomer overcoat 14.

FIG. 7 illustrates an alternative embodiment to that shown in FIG. 4 wherein the ionomer overcoat layer 14 is interposed between a catalyst layer 12 and a microporous layer 22 on a gas diffusion media layer 20.

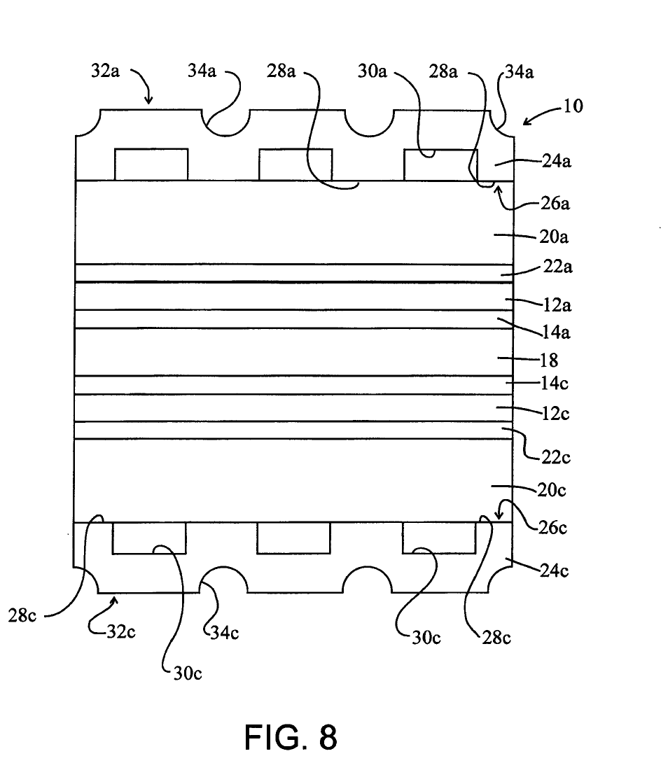

FIG. 8 illustrates a product 10 according to another embodiment of the invention including a portion of a fuel cell stack including a polyelectrolyte membrane 18 including an anode layer 12a including a catalyst therein overlying the polyelectrolyte membrane 18. A first overcoat layer 14a is interposed between the anode layer 12a and the polyelectrolyte membrane 18. Similarly, a cathode layer 12c with a catalyst therein is provided underlying the polyelectrolyte membrane 18. A second ionomer modified overcoat 14c is interposed between the catalyst layer 12c and the polyelectrolyte membrane 18. An anode gas diffusion media layer 20a and an optional microporous layer 22a overlie the anode layer 12a A first bipolar plate 24a overlies the anode gas diffusion media layer 20a. The first bipolar plate 24a includes a first face 26a including a plurality of lands 28a and channels 30a defined therein to provide a reactant gas flow field. The first bipolar plate 24a may include a second face 32a including cooling channels 14a formed therein. Similarly, a cathode gas diffusion media layer 20c and an optional microporous layer 22c underlie the cathode layer 12c. A second bipolar plate layer 24c is provided underlying the cathode gas diffusion media layer 20c. The second bipolar plate 24c includes a first face 26c including a plurality of lands 28c and channels 30c to define a reactant gas flow field. The second bipolar plate 24c includes a second face 32c including cooling channels formed therein.

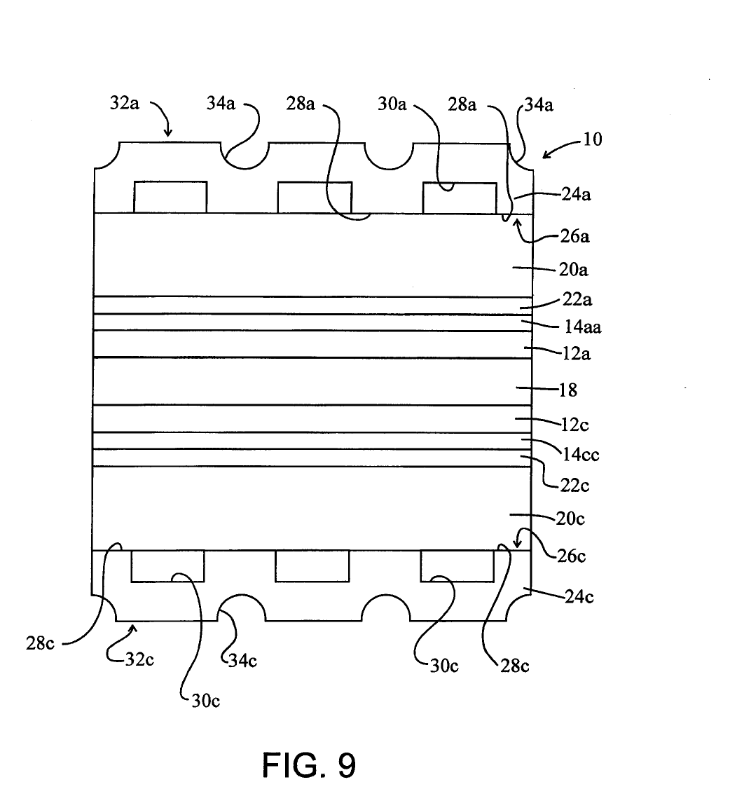

FIG. 9 illustrates another embodiment wherein an ion modified ionomer overcoat layer 14aa is interposed between the anode catalyst layer 12a and one of the anode microporous layer 22a or anode gas diffusion media layer 20a. Similarly, an ion modified ionomer overcoat layer 14cc is interposed between the cathode catalyst layer 12c and one of the cathode microporous layer 22c or cathode gas diffusion media layer 20c.

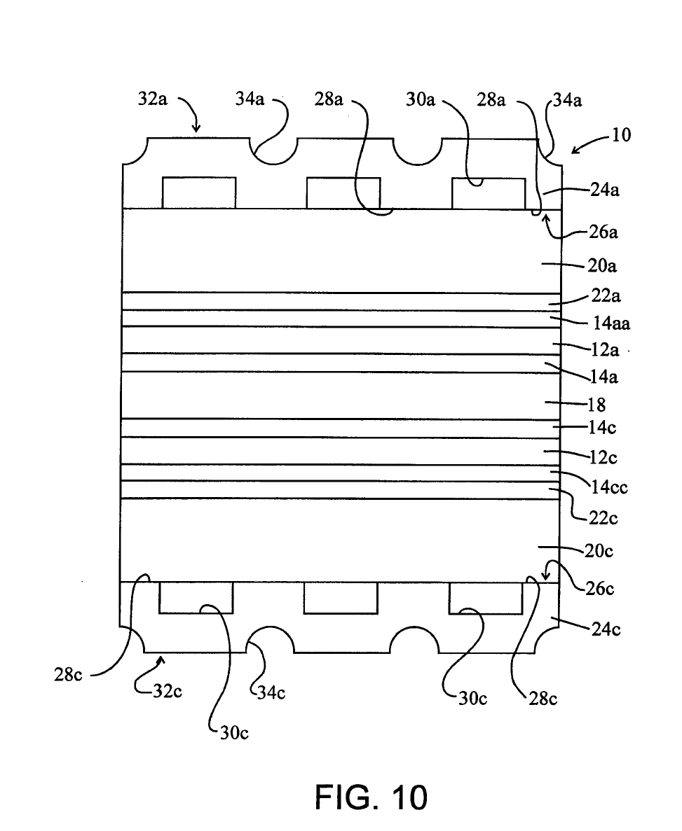

FIG. 10 illustrates another embodiment wherein a first anode ion modified ionomer overcoat layer 14a is interposed between the anode catalyst layer 12a and the membrane 18. A second ion modified ionomer overcoat layer 14aa is interposed between the anode catalyst layer 12a and one of the anode microporous layer 22a or anode gas diffusion media layer 20a. Similarly, a first cathode ion modified ionomer overcoat layer 14c is interposed between the cathode catalyst layer 12c and the membrane 18. A second cathode ion modified ionomer overcoat layer 14cc is interposed between the cathode catalyst layer 12c and one of the cathode microporous layer 22c or cathode gas diffusion media layer 20c.

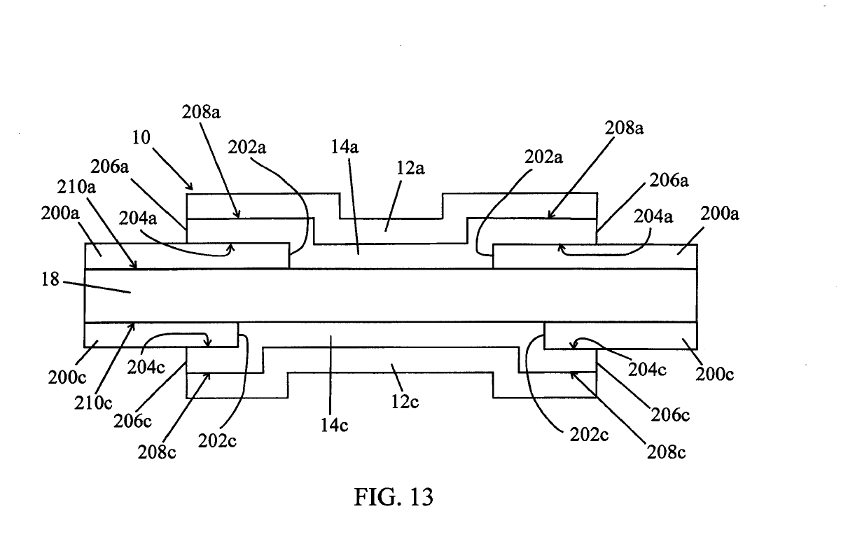

FIG. 13 illustrates another embodiment of the invention including a product 10 comprising a polyelectrolyte membrane 18 and an anode subgasket 200a over a first face 210a of the membrane 18. The anode subgasket 200a includes a window formed therein defined by an inner edge 202a that exposed a portion of the first face 210a of the membrane 18 defining an active area of the anode side of the membrane 18. An anode ion modified ionomer overcoat layer 14a is provided in the anode subgasket window 202a. The portion 204a of the anode ion modified ionomer overcoat layer overlapping the anode subgasket 200a prevents or substantially reduces pinholes along the inner edge 202a of the anode subgasket and under the subgasket 200a.

Likewise, a cathode subgasket 200c may be provided over a second face 210c of the membrane 18. The cathode subgasket 200c includes a window formed therein defined by an inner edge 202c that exposed a portion of the second face 210c of the membrane 18 defining an active area of the cathode side of the membrane 18. A cathode ion modified ionomer overcoat layer 14c is provided in the cathode subgasket window 202c and includes a portion 204c that overlaps a portion of the cathode subgasket 200c. The portion 204c of the cathode ion modified ionomer overcoat layer overlapping the cathode subgasket 200c prevents or substantially reduces pinholes along the inner edge 202c of the cathode subgasket and under the subgasket 200c. The cathode catalyst layer 12c may also include a portion 206c that overlaps the cathode subgasket 200c. In this embodiment the opening in the anode subgasket window 202a is smaller than the opening in the cathode subgasket window 202c. For example, the opening or active area on the anode side may be 38 cm², while the opening or the active area on the cathode side may be 44 cm². Further, the ends 208c of the cathode ion modified ionomer overcoat layer 14c may extend laterally beyond the ends 208a of the anode ion modified ionomer overcoat layer 14a.

The above description of embodiments of the invention is merely exemplary in nature and, thus, variations thereof are not to be regarded as a departure from the spirit and scope of the invention.

What is claimed is:

1. A method comprising:
applying an ionomer solution to a substrate comprising at least one of a decal backing, a polyelectrolyte membrane, a gas diffusion media layer, a microporous layer, a catalyst coated membrane, a catalyst coated gas diffusion media or an electrode including a catalyst, the ionomer solution including an ionomer modified to include at least one of a cerium or manganese group.

2. A method as set forth in claim 1 wherein the substrate is an electrode.

3. A method as set forth in claim 1 wherein the substrate comprises a decal backing material.

4. A method as set forth in claim 1 wherein the substrate comprises a polyelectrolyte membrane.

5. A method as set forth in claim 1 wherein the substrate comprises a gas diffusion media layer.

6. A method as set forth in claim 1 wherein the substrate comprises a gas diffusion media layer coated with a microporous layer.

7. A method as set forth in claim 1 wherein the applying comprises at least one of spraying, dipping, screen printing, rolling, coating, or brushing.

8. A method as set forth in claim 3 further comprising hot pressing the overcoat layer, and decal backing material to a polyelectrolyte membrane and removing the decal backing material so that the overcoat layer faces the polyelectrolyte membrane.

9. A method as set forth in claim 5 further comprising placing the overcoat against a first face of a polyelectrolyte membrane.

10. A method as set forth in claim 6 further comprising placing the overcoat layer against a polyelectrolyte membrane.

11. A method comprising:
modifying an ionomer comprising dissolving a salt of at least one of cerium or manganese in a solution including an ionomer and a vehicle.

12. A method as set forth in claim 11 wherein the salt comprises a carbonate salt of cerium or manganese.

13. A method as set forth in claim 12 wherein the vehicle comprises at least one of water or alcohol.

14. A method as set forth in claim 12 wherein the vehicle comprises at least one of ethanol, methanol, propanol or butanol.

15. A method as set forth in claim 12 further comprising applying the solution to an electrode comprising a catalyst.

16. A method as set forth in claim 15 further comprising a substrate supporting the electrode.

17. A method as set forth in claim 16 wherein the substrate comprises a decal backing material.

18. A method as set forth in claim 16 wherein the substrate comprises a polyelectrolyte membrane.

19. A method as set forth in claim 16 wherein the substrate comprises a gas diffusion media layer.

20. A method as set forth in claim 16 wherein the substrate comprises a gas diffusion media layer coated with a microporous layer.

21. A method comprising
providing an ionomer comprising proton groups,
substituting a Ce or Mn ion for at least one of the proton groups comprising mixing a salt of Ce or Mn with the ionomer in a solution.

22. A method as set forth in claim 21 wherein the proton groups comprise a sulfonic acid group.

23. A method as set forth in claim 21 further comprising a catalyst in the solution.

24. A method as set forth in claim 21 further comprising coating the solution and drying the same to form a substrate.

25. A method as set forth in claim 21 wherein the salt is Ce₂(CO₃)₃.

26. A method as set forth in claim 21 wherein the salt is MnCO₃.

27. A product comprising:
an electrode layer comprising a catalyst, and an overcoat over the electrode layer, the overcoat comprising an ionomer modified to comprise at least one of a cerium or manganese group.

28. A product as set forth in claim 27 wherein the ionomer comprises a perfluorinated sulfonic acid polymer.

29. A product as set forth in claim 27 further comprising a substrate underlying the electrode layer.

30. A product as set forth in claim 29 wherein the substrate comprises a decal backing material.

31. A product as set forth in claim 29 wherein the substrate comprises a polyelectrolyte membrane.

32. A product as set forth in claim 29 wherein the substrate comprises a gas diffusion media layer.

33. A product as set forth in claim 29 wherein the substrate comprises a gas diffusion media layer with a microporous layer coated thereon.

34. A product as set forth in claim 27 further comprising a polyelectrolyte membrane adjacent the overcoat layer.

35. A product comprising:
at least one fuel cell comprising a polyelectrolyte membrane having a first face and an opposite second face, an anode over the first face of the membrane and a cathode over the second face of the membrane, and wherein the anode comprises a catalyst for dissociating a fuel to provide protons and the cathode comprising a catalyst for catalyzing the reaction of a proton and oxygen, a cathode side gas diffusion media layer over the cathode and an anode side gas diffusion media layer over the anode;
a first anode side ionomer overcoat interposed between the anode and membrane or interposed between the anode and the anode side gas diffusion media layer, the first anode side ionomer overcoat comprising an ionomer modified to comprise at least one of a cerium or manganese group;
a first cathode side ionomer overcoat interposed between the cathode and membrane or interposed between the cathode and the cathode side gas diffusion media layer, the first cathode side ionomer overcoat comprising an ionomer modified to comprise at least one of a cerium or manganese group.

36. A product as set forth in claim 35 wherein the first anode side ionomer overcoat comprises the cerium group and the first cathode side ionomer overcoat comprises the manganese group.

37. A product as set forth in claim 35 wherein the first anode side ionomer overcoat comprises the manganese group and the first cathode side ionomer overcoat comprises the cerium group.

38. A product as set forth in claim 35 wherein the first anode side ionomer overcoat is interposed between the anode and membrane, and further comprising a second anode side ionomer overcoat interposed between the anode and the anode side gas diffusion media layer, the second anode side ionomer overcoat comprising an ionomer modified to comprise at least one of a cerium or manganese group.

39. A product as set forth in claim 35 wherein the first cathode side ionomer overcoat is interposed between the cathode and membrane, and further comprising a second cathode side ionomer overcoat interposed between the cathode and the cathode side gas diffusion media layer, the second cathode side ionomer overcoat comprising an ionomer modified to comprise at least one of a cerium or manganese group.

40. A product comprising:
a fuel cell polyelectrolyte membrane having a first face and a second face, a first subgasket over the first face, the first subgasket having an inner edge defining a first window exposing a portion of first face of the membrane, a first ion modified ionomer overcoat layer having a portion received in the first window and a portion of the first ion modified ionomer overcoat layer overlapping a portion of the first subgasket.

41. A product as set forth in claim 40 further comprising a second subgasket over the second face, the second subgasket having an inner edge defining a second window exposing a portion of second face of the membrane, a second ion modified ionomer overcoat layer having a portion received in the second window and a portion of the second ion modified ionomer overcoat layer overlapping a portion of the second subgasket.

42. A product as set forth in claim 41 wherein the area of the first face of the membrane exposed by the first window is smaller than the area of the second face of the membrane exposed by the second window.

43. A product as set forth in claim 41 further comprising an anode catalyst layer overlying the first ion modified ionomer overcoat layer, and a cathode catalyst layer overlying the second ion modified ionomer overcoat layer.

44. A product as set forth in claim 43 wherein the first ion modified ionomer overcoat layer is interposed between the anode catalyst layer and the membrane.

45. A product as set forth in claim 43 wherein the second ion modified ionomer overcoat layer is interposed between the cathode catalyst layer and the membrane.

46. A product as set forth in claim 40 wherein the first overcoat layer comprises a cerium or manganese group.

47. A product as set forth in claim 41 wherein the second overcoat layer comprises a cerium or manganese group.
